(19) United States
(12) Patent Application Publication
(10) Pub. No.: US 2005/0092199 A1
(43) Pub. Date: May 5, 2005

(54) Method and device for transversely tautening a print-carrier sheet and machine having the device

(75) Inventors: Thomas Schafer, Heidelberg (DE); Frank Schramm, Furfeld (DE); Uwe Angst, Jockgrim (DE); Andreas Bottger, Heidelberg (DE); Ulrich Fellenberg, Schwetzingen (DE); Christian Low, Limburg (DE)

Correspondence Address: LERNER AND GREENBERG, PA, P O BOX 2480, HOLLYWOOD, FL, 33022-2480, US

(73) Assignee: Heidelberger Druckmaschinen Aktiengesellschaft

(21) Appl. No.: 10/978,200

(22) Filed: Oct. 29, 2004

(30) Foreign Application Priority Data
Oct. 29, 2003 (DE) 103 50 537.7

(51) Int. Cl. B41F 1/30

(52) U.S. Cl. 101/408

(57) ABSTRACT

A method for transversely tautening a print-carrier sheet includes applying a twisting movement to a belt and transversely tautening the print-carrier sheet with the belt having the twisting movement. A device for performing the method and a print-carrier sheet processing machine, such as a sheet-fed printing press, including the device, are also provided.

### BACKGROUND OF THE INVENTION

### FIELD OF THE INVENTION

The present invention relates to a method and a device for transversely tautening a print-carrier sheet and a to machine having the device.

Devices of this general type are used in deliveries of printing presses for the purpose of improving the stackability of sheets by reducing sagging in the direction of the width of the sheet due to the transverse tautening. Moreover, devices of this general type can additionally act as a sheet brake. For example, a sheet brake having a transverse tautening effect is described in German Published, Non-Prosecuted Patent Application DE 39 39 212 A1. That sheet brake includes suction rings for contacting the sheet in so-called print-free corridors thereof. Some of the suction rings are inclined relatively to the sheet running or travel direction in order to achieve the transverse tautening effect.

The more pronounced the inclination of the suction rings, the wider the print-free corridors must be. In general, however, it is desirable to keep the print-free corridors as narrow as possible, in order to optimize the use of the sheet format during printing and to minimize the trimming of wastage. A reduction in the inclination of the suction rings, which would serve those aims would, however, necessarily be associated with a reduction in the transverse tautening effect and consequently a deterioration in the stackability of the sheets.

### SUMMARY OF THE INVENTION

It is accordingly an object of the invention to provide a method and a device for transversely tautening a print-carrier or printing-material sheet which has only a very narrow print-free corridor, as well as a machine having the device, which overcome the hereinafore-mentioned disadvantages of the heretofore-known methods and devices of this general type.

With the foregoing and other objects in view, there is provided, in accordance with the invention, a method for transversely tautening a print-carrier sheet. The method comprises applying a twisting movement to a belt and transversely tautening the print-carrier sheet with the belt having the twisting movement.

With the objects of the invention in view, there is also provided a device for transversely tautening a print-carrier sheet. The device comprises a belt with a twisting movement. The belt with the twisting movement transversely tautens the print-carrier sheet.

In accordance with a further feature of the invention, the belt has revolving axes. A twisting run is oriented obliquely with respect to the revolving axes.

In accordance with an added feature of the invention, the belt has wrap-around sections. The sections are offset from one another along the revolving axes.

In accordance with an additional feature of the invention, the belt is formed with kinks. The twisting run merges into the wrap-around sections at the kinks.

In accordance with yet another feature of the invention, the belt is a round belt.

In accordance with yet a further feature of the invention, the belt is a brake belt.

In accordance with yet an added feature of the invention, the device further includes another belt to which a twisting movement is applicable, like the first-mentioned belt.

In accordance with yet an additional feature of the invention, the twisting movements of the two belts are in opposite directions to one another.

With the objects of the invention in view, there is additionally provided a print-carrier sheet processing machine. The machine comprises a device for transversely tautening a print-carrier sheet. The device has a belt to which a twisting movement is applicable.

In accordance with a concomitant feature of the invention, the print-carrier sheet processing machine is constructed as a sheet-fed printing press.

The method according to the invention which serves for transversely tautening a print-carrier or printing-material sheet is distinguished by providing a belt with a twisting movement for this purpose. The device according to the invention which serves for transversely tautening a print-carrier or printing-material sheet has such a belt to be provided with a twisting movement.

The twisting movement is a rotational movement which guides the profile of the belt around an imaginary pivot point lying within this profile. The belt is shaped, disposed and driven in such a way as to perform the twisting movement. The twisting movement forms a first movement component of the belt which is superimposed upon a second movement component resulting from an inclination of the belt. The resultant of the superimposition of the two movement components is greater than the second movement component. The transverse tautening is effected transversely, i.e. perpendicularly or obliquely, to the so-called travel or running direction of the print-carrier or printing-material sheet.

In the invention of the instant application, a reduction in the inclination of the belt, which reduction is performed for the purpose of narrowing the print-free corridors, is also necessarily associated with a decrease in the second movement component. However, the first movement component/twisting movement is capable of compensating for the decrease. Therefore, sufficiently great transverse tautening is allowed with the invention despite the narrowness of the print-free corridors. The narrowness of the print-free corridors which is made possible by the invention is, in turn, advantageous with regard to optimizing the use of the sheet format during printing and with regard to minimizing the trim wastage produced when the print-free corridors are cut off.

The invention further relates to a print-carrier or printing-material sheet processing machine. More particularly, the invention relates to a sheet-fed printing press, which is equipped with the device according to the invention.

Other features which are considered as characteristic for the invention are set forth in the appended claims.

Although the invention is illustrated and described herein as embodied in a method and a device for transversely tautening a print-carrier or printing-material sheet and a machine having the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, side-elevational view of a sheet-fed printing press having a multi-functioning sheet brake functioning also as a device for transversely tautening;

FIG. 2 is an enlarged, fragmentary, top-plan view of FIG. 1, showing the sheet brake in a viewing direction II indicated in FIG. 1;

FIG. 3 is a side-elevational view of a brake module of the sheet brake;

FIG. 4 is a cross-sectional view of the brake module, which is taken along a line IV-IV of FIG. 3, in the direction of the arrows; and

FIG. 5 is a plan view of FIG. 3.

### DESCRIPTION OF THE PREFERRED EMBODIMENTS

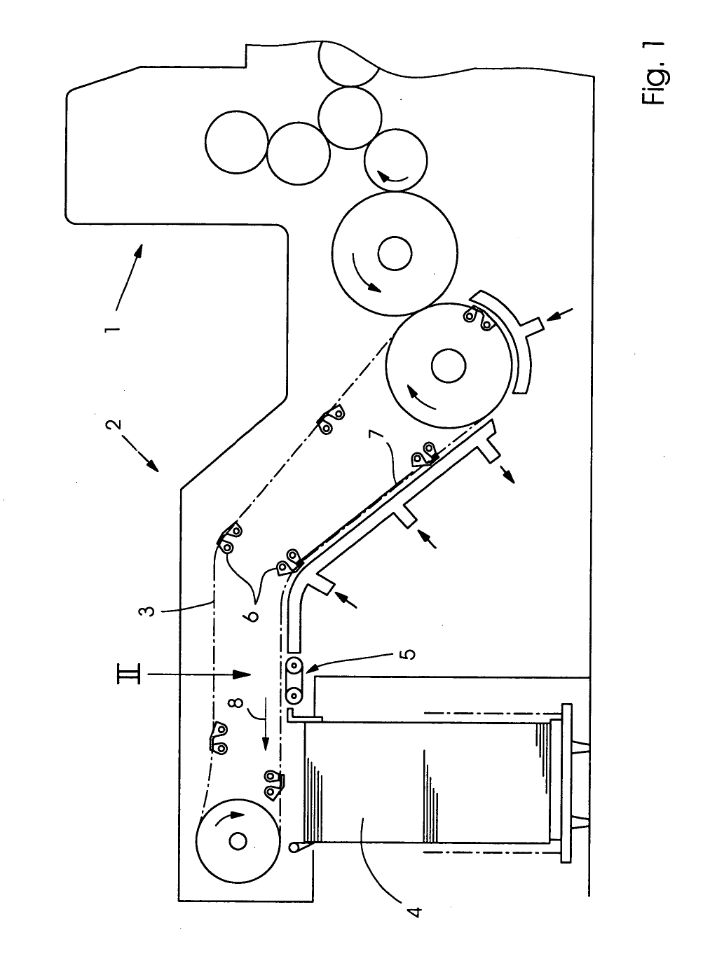

Referring now to the figures of the drawings in detail and first, particularly, to FIG. 1 thereof, there is seen a sheet-fed printing press 1 having a sheet delivery 2. The sheet delivery 2 includes a chain conveyor 3, a delivery stack or pile 4 and a sheet brake 5. The chain conveyor 3 drags print-carrier or printing-material sheets 7 along a sheet travel direction 8 to the delivery pile 4, through the use of gripper systems 6. The sheet brake 5 is disposed below the chain conveyor 3 and, as viewed in the sheet travel direction 8, in front of the delivery pile or stack 4.

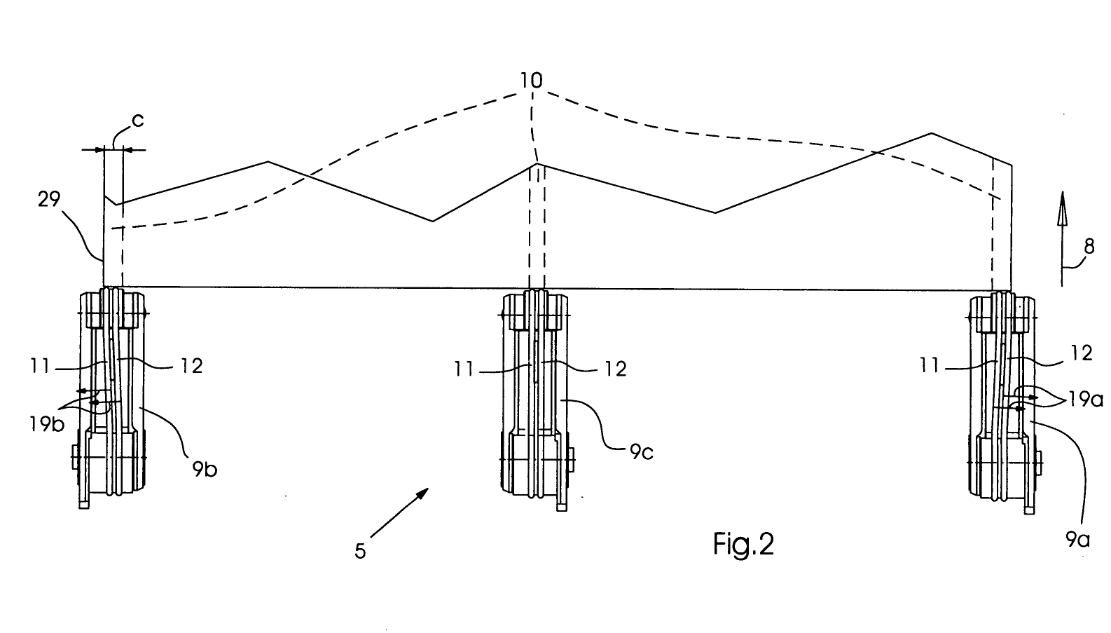

In FIG. 2, the sheet brake 5 is shown as including only three brake modules 9a to 9c, namely a brake module 9a on the drive side of the sheet-fed printing press 1, a brake module 9b on the operator side, and a central brake module 9c which is disposed exactly in the center between the brake modules 9a and 9b. The brake modules 9a to 9c are at least approximately aligned with print-free corridors 10 on the underside of the print-carrier or printing-material sheet 7. Those print-free corridors 10 with which the two outer brake modules 9a and 9b are aligned are print-free sheet edges. Due to the small amount (three in number) of brake modules 9a to 9c, only a likewise small amount of print-free corridors 10 are required and, accordingly, a particularly large proportion of the surface of the print-carrier or printing-material sheet 7 is available for the printed image thereof.

Each brake module 9a to 9c includes a belt set formed of a first belt 11 and a second belt 12 running parallel to the first belt 11. When the print-carrier or printing-material sheet 7 is being braked in the sheet travel or running direction 8 and simultaneously tautened transversely (specifically obliquely or inclined in this case) with respect to the sheet travel or running direction 8, the belts 11 and 12 make contact with the print-free corridors 10 of the print-carrier or printing-material sheet 7. With respect to the sheet travel or running direction 8, the belts 11 and 12 of the two outer brake modules 9a and 9b are set to be oblique or inclined in sections of the belt length, and the belts 11 and 12 of the central brake module 9c are set to be parallel over the entire belt length thereof. The local belt inclination is selected in such a way that, as viewed in the sheet travel or running direction 8, the belts 11 and 12 of the drive-side brake module 9a deviate from the belts 11 and 12 of the operator-side brake module 9b. Furthermore, it is believed to be apparent from FIG. 2 that the two outer print-free corridors 10, despite the belt inclination of the brake modules 9a and 9b assigned thereto, are only insignificantly wider than the central corridor 10 to which the central brake module 9c without belt inclination is assigned. This advantage results from the small size of an angle of inclination a (note FIG. 5) of the belts 11 and 12 of the outer brake modules 9a and 9b.

According to one modification which is not shown in greater detail in the drawing, it would also be possible, in order to reduce the corridor width further, to equip the brake modules 9a to 9c with only a single belt each instead of the belt set. For example, the first belt 11 would remain and the second belt 12 would be omitted.

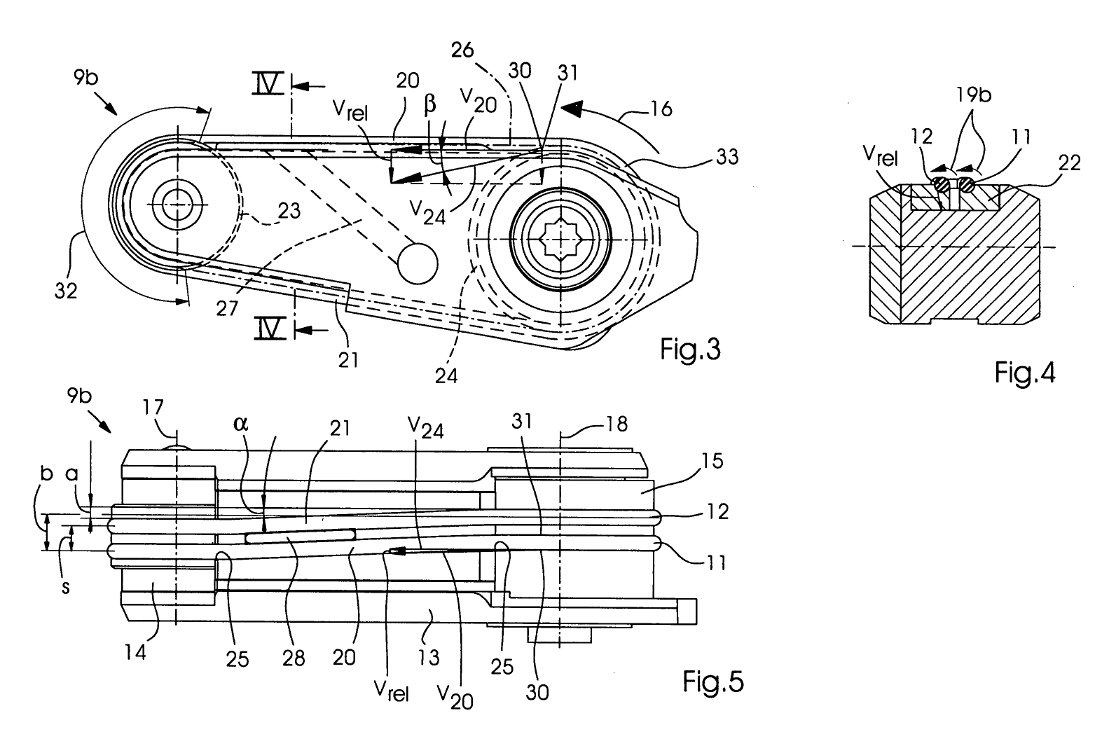

Referring to FIGS. 3 to 5, the hereinafter following text explains the structural conditions of the operator-side brake module 9b in detail. Those structural conditions are valid in an equivalent sense for the drive-side brake module 9a which is configured as a mirror image of the operator-side brake module 9b. The brake module 9b has a basic body 13 wherein a front roller 14 and a rear roller 15, as viewed relative to the sheet travel or running direction 8 (note FIG. 2), are rotatably mounted for guiding the endless belts 11 and 12. The rear roller 15 serves as a drive roller for effecting a revolving movement (represented by the curved arrow 16) of the belts 11 and 12, and the front roller 14 serves as a deflection roller for deflecting the belts 11 and 12. The rollers 14 and 15 define revolving axes 17 and 18 about which the belts revolve in synchronism with one another.

The belts 11 and 12 are driven in such a manner that, at least at the beginning of the braking process, a difference in velocity exists between the velocity of the revolving movement represented by the curved arrow 16 and the velocity determined by the chain conveyor 3 of the print-carrier or printing-material sheet 7 to be braked and, in the process, tautened transversely. Each belt 11, 12 is, therefore, a brake belt. It is believed to be apparent from FIG. 4 that each belt 11, 12 is a round belt and, therefore, has a belt profile with a circular contour. The belt profile of the respective belts 11 and 12 performs a twisting movement represented by the respective arrows 19a and 19b in FIGS. 2 and 4.

It is believed to be readily apparent from FIG. 3, wherein the first belt 11 is shown, by way of example, that each belt 11, 12 has an upper, first run or strand 20 and a lower, second run or strand 21. The first run 20 is a return run or strand and the second run 21 is a load run or strand. It is believed to be readily apparent from FIG. 4 that the first run 20 is not self-supportingly subject to tension but rather is guided in a belt bed 22. The belts 11 and 12 are respectively guided in a circumferential annular groove 23 formed in the front roller 14 and an annular groove 24 of identical type formed in the rear roller 15, with the formation of wrap-around sections 32 and 33 of the respective belts 11 and 12. The wrap-around sections 32 and 33 of the respective belt 11 and 12, for example of the belt 11, are offset with respect to one another along the revolving axes 17 and 18. The belts 11 and 12 each have two kinks 25 at which the respective wrap-around sections 32 and 33 merge into the first run 20. With regard to minimizing the necessary complexity in terms of mechanism technology for driving the belts 11 and 12 (omission of clutches for angular compensation), it is advantageous for the revolving axes 17 and 18 to be aligned precisely perpendicularly relative to the sheet running or travel direction 8 (note FIG. 2).

The first run 20 of the respective belt 11, 12 performs the twisting movement 19b about an imaginary central strand 26 which determines the pivot point thereof and is, therefore, also referred to herein as the twisting run. This respective twisting run of the belts 11 and 12 is not aligned perpendicularly but rather, in accordance with the angle of inclination a, obliquely with respect to the revolving axes 17 and 18 of the respective belts 11 and 12. The annular grooves 23 and 24 are concentric with the revolving axes 17 and 18. The two kinks 25 of each respective belt 11 and 12 have different kink or turn directions relative to one another, so that the respective belt 11 and 12 extends or runs in a cranked manner, i.e. alternately angled away. These belt angle deviations are very small, with the angle of inclination α being indeed greater than 0° but smaller than 5°.

Consequently, the twisting movement represented by the curved arrow 19a does not take place absolutely perpendicularly with respect to the sheet travel or running direction 8, but rather approximately perpendicularly with respect to the latter.

A vacuum line 27 is introduced into the basic body 13 and opens into a groove-shaped vacuum duct 28 of the belt bed 22. The duct 28 is open at the top or towards the print-carrier or printing-material sheet 7 to be tautened. The vacuum line 27 is configured as a drilled or bored hole and is connected to a non-illustrated vacuum source. The vacuum duct 28 is situated-between the two belts 11 and 12 and, even in the modification which has been mentioned above wherein the second belt 12 was omitted, would be situated directly adjacent the first belt 11. The vacuum duct 28 serves for drawing the print-carrier or printing-material sheet 7 pneumatically to the belts 11 and 12 and for holding the sheet 7 on the latter. Therefore, a frictional connection which brakes and laterally tautens the print-carrier or printing-material sheet 7 comes into effect between the belts 11 and 12, on one hand, and the print-carrier or printing-material sheet 7, on the other hand.

The belts 11 and 12 run equidistantly to one another in sections, at a belt spacing s corresponding approximately to twice the diameter of the respective belts 11 and 12. An angle of inclination a between the sheet guiding direction represented by the arrow 8 and the first run (twisting run) 20 of each belt 11 and 12 results from a groove offset a between the front annular groove 23 and the rear annular groove 24. The groove offset a is measured axially parallel to the revolving axes 17 and 18. The two annular grooves 23 and 24 are disposed out of alignment with one another and are respectively disposed offset axially parallel to one another. The front annular groove 23 is situated closer than the rear annular groove 24 to a lateral edge 29 (note FIG. 2) of the print-carrier or printing-material sheet 7 lying closest to the brake module 9b. The rear annular groove 24 is disposed closer to the center of the sheet 7 than the front annular groove 23. A corridor width c shown in FIG. 2 must be at least as wide as a contact width b (shown in FIG. 5) of the sheet brake 5 and can advantageously be kept small due to the method of operation of the invention as explained below.

Due to the revolving movement represented by the arrow 16, the print-carrier or printing-material sheet 7 which is in contact with the belts 11 and 12 is respectively conveyed in the transverse direction and transversely tautened an amount corresponding to the groove offset a on the path of the sheet 7 along the sheet brake 5. At the same time, the groove offset a produces the twisting movement 19b of the belts 11 and 12 which is likewise respectively oriented outwardly and in the transverse direction. The twisting movement 19b of each belt 11, 12 of the operator-side brake module 9b is oriented towards the lateral edge 29 in the region of the belt surface which is in contact with the print-carrier or printing-material sheet 7.

The twisting movement represented by the curved arrows 19b is produced by the different behavior of the respective belts 11 and 12 at a contact point 30 and at a separation point 31 of the corresponding belt. The contact point 30 and the separation point 31 are situated opposite one another on flanks or edges of the rear annular groove 24 and, with regard to the rear roller 15, approximately at that circumferential point at which the wrap-around section 33 of the belt merges into the first run (twisting run) 20. The contact point 30 lies on that side of the respective belt 11 or 12 towards which the belt is turned or kinked at the kink or turning point 25 defined by the rear roller 15, and the separation point 31 lies on the opposite belt side. At the separation point 31, the belt has already been respectively detached from and lifted off the respective flank or edge of the rear annular groove 24, while it is still in contact with the respective annular groove 24 and edge thereof at the contact point 30. At the contact point 30, the transition from static friction between the annular groove 24 and the respective belt 11 and 12 to sliding friction occurs, and the rear roller 24 has a tangential velocity v₂₄ and the first run 20 has a belt velocity v₂₀. With respect to FIG. 3, a vector for the belt velocity v₂₀ is directed horizontally to the left-hand side and a vector for the tangential velocity v₂₄ is directed downwardly and to the left-hand side, with the result that the two velocities v₂₀, v₂₄ enclose an angle β between one another in the vertical projection. By studying FIGS. 2 and 5 together, it can be seen that the vector for the belt velocity v₂₀ is directed in the running or travel direction of the first run 20 and that the vector for the tangential velocity v₂₄ is directed in the sheet running or travel direction 8, with the result that the vectors for the two velocities v₂₀, v₂₄ enclose an angle having a magnitude corresponding to the angle of inclination α in the horizontal projection (note FIG. 5). The resultant of the two velocities v₂₀, v₂₄ is a relative velocity vᵣₑₗ, in the acting direction of which the sliding friction force acting on the respective belt 11 or 12 also acts. This sliding friction force ultimately produces the respective twisting of the respective belt 11 or 12 about the central strand 26 thereof and the twisting movement 19b which is perpendicular to the central strand 26. A respective flank or edge of the rear annular groove 24 should be exactly as high as the other respective flank or edge opposite thereto, in order for the respective belt 11 or 12 to be twisted uniformly.

It is believed to be readily apparent from FIG. 2 that the belts 11, 12 of the drive-side brake module 9a likewise perform a respective twisting movement 19a which is in the opposite direction to the twisting movement 19b of the belts 11, 12 of the operator-side brake module 9b. As viewed in the sheet running or travel direction 8, the twisting movement 19a is performed in clockwise direction and the twisting movement 19b is performed in counterclockwise direction, with the result that the print-carrier or printing-material sheet 7 is tautened uniformly towards both sheet sides by the twisting movements represented by the arrows 19a and 19b.

This application claims the priority, under 35 U.S.C. § 119, of German Patent Application 103 50 537.7, filed Oct. 29, 2003; the entire disclosure of the prior application is herewith incorporated by reference.

1. A method for transversely tautening a print-carrier sheet, which comprises:
applying a twisting movement to a belt; and
transversely tautening the print-carrier sheet with the belt having the twisting movement.

2. A device for transversely tautening a print-carrier sheet, the device comprising:
a belt with a twisting movement, said belt with said twisting movement transversely tautening the print-carrier sheet.

3. The device according to claim 2, wherein said belt has revolving axes and a twisting run oriented obliquely relative to said revolving axes.

4. The device according to claim 3, wherein said belt has wrap-around sections mutually offset along said revolving axes.

5. The device according to claim 4, wherein said belt has kinks, and said twisting run merges into said wrap-around sections at said kinks.

6. The device according to claim 2, wherein said belt is a round belt.

7. The device according to claim 2, wherein said belt is a brake belt.

8. The device according to claim 2, further comprising another belt with a twisting movement.

9. The device according to claim 8, wherein said twisting movements of said belts are in mutually opposite directions.

10. A print-carrier sheet processing machine, comprising:
a device for transversely tautening a print-carrier sheet, the device including a belt with a twisting movement, said belt with said twisting movement transversely tautening the print-carrier sheet.

11. A sheet-fed printing press, comprising:
a device for transversely tautening a sheet printed in the printing press, the device including a belt with a twisting movement, said belt with said twisting movement transversely tautening the sheet.
